(19) United States
(12) Patent Application Publication
(10) Pub. No.: US 2007/0174329 A1
(43) Pub. Date: Jul. 26, 2007

(54) Presenting a reason why a secondary data structure associated with a database needs rebuilding

(75) Inventors: Mark John Anderson, Oronoco, MN (US); James Michael Flanagan, Rochester, MN (US); Thomas P. Giordano, Rochester, MN (US); Rafal P. Konik, Oronoco, MN (US); Ritchie Lee Nyland, Rochester, MN (US); Mark William Theuer, Rochester, MN (US); Wilson Paul Ward, Wabasha, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/340,341

(22) Filed: Jan. 26, 2006

(51) Int. Cl. G06F 7/00

(52) U.S. Cl. 707/102

(57) ABSTRACT

In response to a request to access a database, a decision is made that a secondary data structure associated with the database needs rebuilding. A reason why the secondary data structure needs rebuilding is determined and the reason is presented via a user interface. In various embodiments, other information may also be presented, such as an identification of the operation associated with the request that encountered the secondary data structure and an identification of a most recent query that used the secondary data structure. In this way, the user may be informed of the reason why a secondary data structure needs rebuilding, so that the user may opt to take action to prevent secondary data structures from needing rebuilding in the future, and thus avoid the expense and time of rebuilding the secondary data structures.

### FIELD

This invention generally relates to computer database management systems and more specifically relates to notification of reasons for rebuilding secondary data structures associated with databases.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Fundamentally, computer systems are used for the storage, manipulation, and analysis of data, which may be anything from complicated financial information to simple baking recipes. It is no surprise, then, that the overall value or worth of a computer system depends largely upon how well the computer system stores, manipulates, and analyzes data. One mechanism for managing data is called a database management system (DBMS), which may also be called a database system.

Many different types of databases are known, but the most common is usually called a relational database (RDB), which organizes data in tables that have rows, which represent individual entries or records in the database, and columns, which define what is stored in each row, entry, or record. Each table has a unique name within the database, and each column has a unique name within the particular table. The database also has an index, which is a data structure that informs the database management system of the location of a certain row in a table given an indexed column value, analogous to a book index informing the reader on which page a given word appears.

The motivation for the existence of the index is that it typically provides faster access to the data in the table than does a simple search of the table. The index typically includes key values and associated pointers to respective rows in the tables where the data associated with the key values (and also the key values themselves) exist. The database management system creates the index from the tables and may create and update the index in response to additions, updates, and deletions to the tables or after the tables have been initialized with data.

If the index does not accurately reflect the state of the data in the tables, then the index is said to be invalid and needs rebuilding. For example, if a new row of data was added to the tables, but a corresponding entry (including the newly created column value and a pointer to the newly added row) was not added to the index because a power outage or error occurred before the index could be updated, then the index is invalid, i.e., inconsistent with the data that exists in the tables. The database management system must rebuild or recreate the invalid index from the tables before the index can become valid and capable of being used to access the tables. This rebuild process can be time consuming, resource intensive, and detrimental to the performance of the database management system and other programs because the rebuild process may need to examine every row in the associated database table and create a corresponding entry in the index that points to the row. Hence, users naturally desire to avoid circumstances that cause the index to become invalid and in need of rebuilding. Unfortunately, users do not necessarily know the reason why the index has become invalid and needs to be rebuilt, so they may be unable to take actions to prevent the index from becoming invalid in the future.

Hence, without a way for users to discover the source of invalid indexes that need rebuilding, they may continue to experience performance degradation. Although the aforementioned problems have been described in the context of an index, they may occur with any secondary data structure used to access a database.

### SUMMARY

A method, apparatus, system, and signal-bearing medium are provided in various embodiments. In response to a request to access a database, a decision is made that a secondary data structure associated with the database needs rebuilding. A reason why the secondary data structure needs rebuilding is determined, and the reason is presented via a user interface. In various embodiments, other information may also be presented, such as an identification of the operation associated with the request that encountered the secondary data structure and an identification of a most recent query that used the secondary data structure. In this way, the user may be informed of the reason why a secondary data structure needs rebuilding, so that the user may opt to take action to prevent secondary data structures from needing rebuilding in the future, and thus avoid the expense and time of rebuilding the secondary data structures.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2A depicts a block diagram of rebuild data, according to an embodiment of the invention.

FIG. 2B depicts a block diagram of a user interface that presents the rebuild data, according to an embodiment of the invention.

FIG. 3 depicts a flowchart of example processing for presenting the rebuild data, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

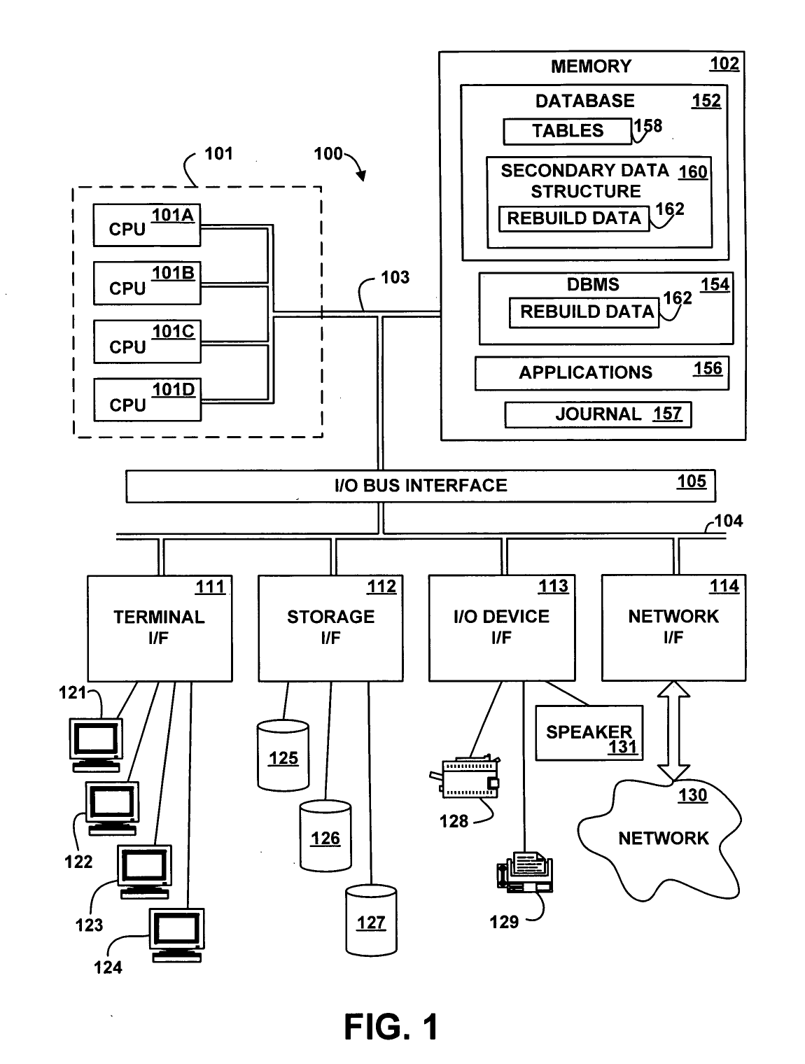

Referring to the Drawings, wherein like numbers denote like parts throughout the several views, FIG. 1 depicts a high-level block diagram representation of a computer system 100 connected to a network 130, according to an embodiment of the present invention. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes a database 152, a database management system 154, applications 156, and a journal 157. Although the database 152, the database management system 154, the applications 156, and the journal 157 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the database 152, the database management system 154, the applications 156, and the journal 157 are illustrated as being contained within the main memory 102, these elements are not necessarily all completely contained in the same storage device at the same time. Further, although the database 152, the database management system 154, the applications 156, and the journal 157 are illustrated as being separate entities, in other embodiments some of them, or portions of some of them, may be packaged together.

The database 152 includes tables 158 of data, e.g., organized in rows and columns. The rows represent individual entries or records in the tables 158. The columns define what is stored in each entry or record. Each table 158 has a unique name within the database 152 and each column has a unique name within the particular table 158. The database 152 may provide keys, where a key is one or more columns in a table 158 that the database 152 uses to sort data. The database management system 154 may allow more than one key, allowing rows to be sorted in different ways. One of the keys is designated the primary key, and must hold a unique value for each row. A key that identifies rows in a different table is called a foreign key. A foreign key is a field (column) in a database record that points to a field (column) of another database record in another table. Usually a foreign key in one table refers to the primary key of the other table.

The database 152 also has a secondary data structure 160, which is a data structure that the database management system 154 uses to access the tables 158. In various embodiments, the secondary data structure 160 may be an index (also called an access path), a hash table, a constraint, or any other type of secondary data structure.

An index informs the database management system 154 of the location of a certain row in a table 158 given an indexed column value, analogous to a book index informing the reader on which page a given word appears. The motivation for the existence of an index is that it typically provides faster access to the data in the tables 158 than a simple search of the table 158. An index typically includes key values and associated pointers to respective rows in the tables 158 where the data associated with the key values (and also the key values themselves) exist. The database management system 154 creates the index from the tables 158 and may create and update the index in response to additions, updates, and deletions to the tables 158 or after the tables 158 have been initialized with data.

A hash table, which may also be called a hash map, associates keys with values in the tables 158. A hash table supports a lookup operation: given a key, the hash table finds the corresponding value. Hash tables are typically implemented using an array. Each element of the array, also called a slot or bucket, contains one key—value pair, or record. Because the number of valid keys is typically much larger than the range of valid indexes into the array, a hash function converts each key into a valid index into the array. The indexed element of the array, in turn, contains the record that is associated to that key. However, when more potential keys exist than available array indexes, then two or more potential keys map to the same array slot (can have the same hash), which is called a collision. To handle collisions, hash tables typically implement a collision resolution strategy, whose function is to find a slot in the array to store a new key if the slot is already occupied. Typical resolution strategies include inserting the colliding record in the next free array slot or providing an array slot to refer to a linked list of records.

Constraints are rules that provide referential integrity, which prevents users or applications from entering inconsistent data between the tables 158. For example, suppose a table named “Table B” has a foreign key that points to a column in a table named “Table A.” Referential integrity might prevent adding a record to Table B (the child table) that cannot be linked to Table A (the parent table). Thus, the value of the foreign key in the record in table B (the child table) must already exist in the corresponding column in table A (the parent table). Hence, the primary key is often called the parent key and the foreign key the child key in the relationship because a child cannot exist without its parent. In addition, the referential integrity rules might also specify that whenever a record is deleted from Table A (the parent table), any records in Table B (the child table) that are linked to the deleted record are also deleted, which is called a cascading delete. Finally, the referential integrity rules may specify that whenever the value in a linked column is modified in Table A, all records in Table B that are linked to it will also be modified accordingly, which is called a cascading update. Thus, cascading deletes and updates enforce the relationship that a child cannot exist without its parent.

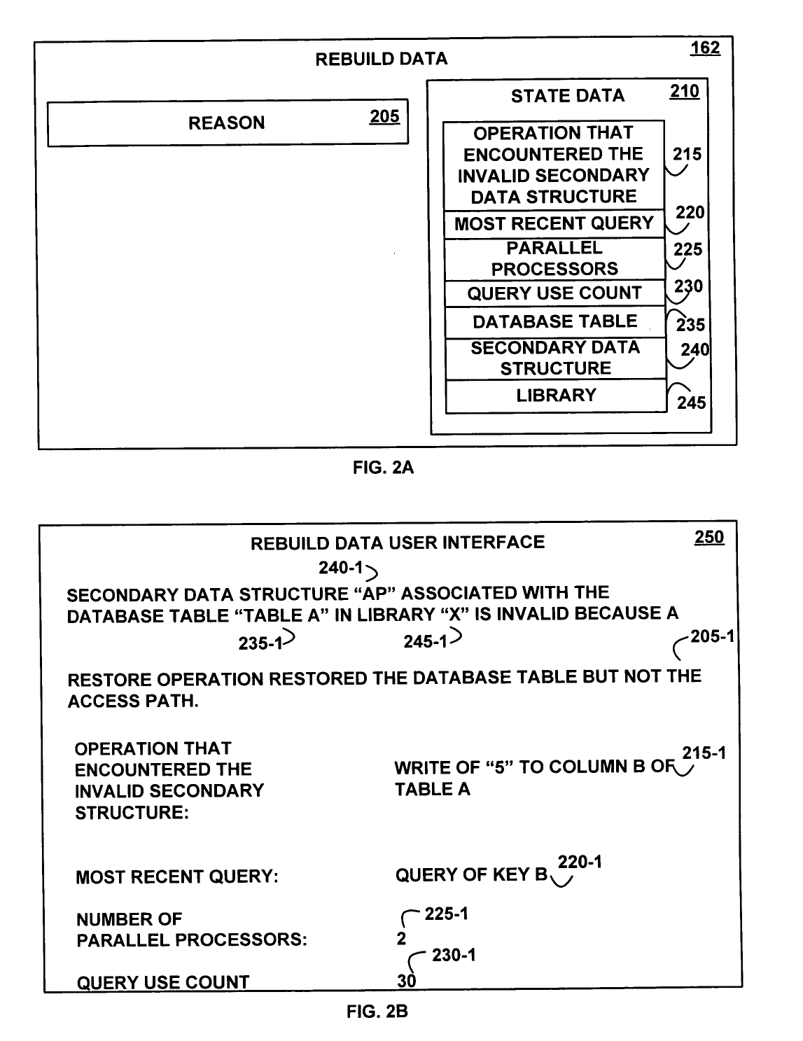

The secondary data structure 160 also includes rebuild data 162, which includes information regarding the reason that the secondary data structure 160 is invalid and needs rebuilding and the state of the tables 158 and the secondary data structure 160. The rebuild data 162 is further described below with reference to FIG. 2A. Presentation or display of the rebuild data 162 is further described below with reference to FIG. 2B.

If the secondary data structure 160 does not accurately reflect the state of the data in the tables 158, the secondary data structure 160 is said to be invalid and needs rebuilding. For example, if a new row of data was added to the tables 158, but a corresponding entry was not added to the secondary data structure 160 because a power outage or error occurred before the secondary data structure 160 could be updated to contain the newly created column value and a pointer to the newly added row, then the secondary data structure 160 is invalid, i.e., inconsistent with the data that exists in the tables 158. But, in other embodiments, many other reasons may cause the secondary data structure 160 to be invalid and need rebuilding. The database management system 154 must rebuild or recreate the invalid secondary data structure 160 from the tables 158 before the secondary data structure 160 becomes valid and capable of being used to access the tables 158.

The database management system 154 may include a copy of the rebuild data 162, a parser, a query optimizer, and primitives. The parser verifies the syntax of a received request and parses the received request to produce a query tree (in the case of a query request) or other parsed code. The query optimizer accepts the query tree or parsed code as input and, in response, creates a query access plan, which in an embodiment may be reused during subsequent executions of the query. The query optimizer may determine the cheapest, or most efficient, way to execute the query. To this end, the query optimizer may generate multiple possible access plans and choose the best one. In doing so, the query optimizer may compare the costs of competing plans, and the costs may include estimated resource requirements determined in terms of time and space. More specifically, the resource requirements may include system information, such as the location of the tables 158 or portions of tables in the database 152, the size of the tables 158, network node locations, system operating characteristics and statistics, estimated runtime for the query, and memory usage, among others.

The query access plan includes low-level information indicating the steps that the primitives are to take to execute the query against the database 152. The query access plan may include, in various embodiments, an identification of the table or tables 158 in the database 152 specified in the query, the row or rows selected in the query, and other information such as whether to use an existing index, whether to build a temporary index, whether to use a temporary file to execute a sort, and/or the order in which the tables 158 are to be joined together to satisfy the query.

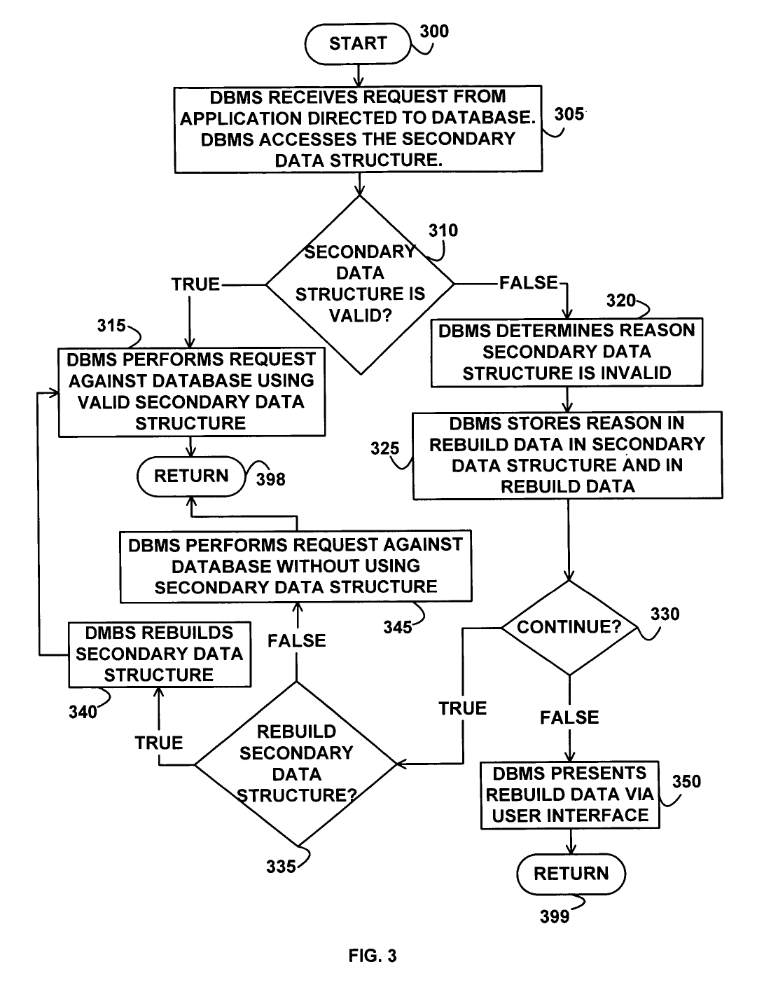

In an embodiment, the database management system 154 includes instructions capable of executing on the processor 101 or statements capable of being interpreted by instructions executing on the processor 101 to perform the functions as further described below with reference to FIG. 3. In another embodiment, the database management system 154 may be implemented in microcode. In another embodiment, the database management system 154 may be implemented in hardware via logic gates and/or other appropriate hardware techniques.

The applications 156 send requests to the database management system 154 to access (add, update, delete, or query) data to to/from the database 152. In an embodiment, a query includes a combination of SQL (Structured Query Language) commands intended to produce one or more output data tables according to a specification included in the query, but in other embodiments any appropriate query language may be used. Although the applications 156 are illustrated as being contained with the memory 102 in the computer system 100, in other embodiments the applications 156 may be on another computer system or other electronic device in the network 130. The applications 156 may be user applications, third-party applications, operating systems, or any portion or combination thereof.

The journal 157 contains journal entries added in response to modification of the tables 158 that reflect the state of the tables 158 prior to the modification. The journal entries may then be used to recover the database tables 158 to a known state following an abnormal system termination or other error. The recovery process often occurs during an IPL (Initial Program Load) following the abnormal system termination. When recovering a saved table 158 to known state, the table 158 is recovered (or rolled back) to a state of its last saved operation occurring sometime prior to the operation that caused the object to become corrupted or enter an invalid or incorrect state. Then, the table 158 is recovered to some later point in time by applying the journaled entries that were recorded in the journal 157. Another use for the recorded changes in the journal 157 is for replicating entries from the journal 157 to a back-up system so that they can be retrieved to create and maintain a replica of the source tables 158.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Three such devices, the printer 128, the fax machine 129, and the speaker 131, are shown in the exemplary embodiment of FIG. 1, but in other embodiment many other such devices may exist, which may be of differing types, and some or all devices may use different I/O device interfaces.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network interface 114 provides one or more communications paths from the computer system 100 to other digital devices and computer systems; such paths may include, e.g., one or more networks 130. The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 and the network 130 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media that may be operatively or communicatively connected (directly or indirectly) to the processor 101. The signal-bearing media include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130.

Such signal-bearing media, when carrying or encoded with computer-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of the rebuild data 162, according to an embodiment of the invention. The rebuild data 162 includes a reason 205 that the secondary data structure 160 is invalid (needs rebuilding) and state data 210 that describes the state of the tables 158 and the secondary data structure 160. The reason 205 indicates the reason or explanation of why the secondary data structure 160 is invalid or an indication of the source that caused the secondary data structure 160 to be invalid and to need rebuilding. The reason 205 may store reasons such as a restore operation restored a table 158 but did not restore the corresponding secondary data structure 160, a system failure occurred during a write operation to the table 158, the table 158 was reorganized, an error occurred that is associated with the journal 157, or any other appropriate reason for the secondary data structure 160 being invalid and needing rebuilding.

A restore operation that restored a table 158 to a previous state but did not restore the corresponding secondary data structure 160 causes the secondary data structure 160 to be invalid because the restore operation changed the data content of the table 158 without also changing the corresponding content of the secondary data structure 160 to match. Hence, any pointers in the secondary data structure 160 may no longer point to rows in the tables 158 with data that correspond to, or are the same as, any key values associated with the pointers in the secondary data structure 160.

A system failure during a write operation to the table 158 causes the secondary data structure 160 to be invalid because the data in the tables 158 may have changed without changing any corresponding data key values and pointers in the secondary data structure 160 to match. A system failure may occur because of a power outage or any other type of error or failure that prevents the secondary data structure 160 from being updated.

A reorganization of the table 158 causes the secondary data structure 160 to be invalid because a reorganize operation may change the location of the rows in the tables 158, which causes any pointers in the secondary data structure 160 that point to the addresses or locations of the rows to no longer be correct. In various embodiments, the location of rows may be changed because the reorganization added columns to the tables 158 or because the reorganization defragmented the tables 158. A journal error causes the secondary data structure 160 to be invalid because a journal error may have prevented the secondary data structure 160 from being updated to correspond to the changes to the tables 158 that initiated the journal operation that encountered the journal error.

The state data 210 may include an operation 215, a most recent query 220, parallel processors 225, a query use count 230, a database table 235, a secondary data structure 240, and a library 245, or any other appropriate information. The operation 215 identifies the operation or request that encountered the invalid secondary data structure, such as a delete, query, insert, or update operation, and may include associated data. The most recent query 220 identifies the most recent query operation that was performed against the table 158 that is associated with the invalid secondary data structure. The parallel processors 225 indicates the number of parallel processors that are recommended to be used to rebuild the invalid secondary data structure. The query use count 230 indicates the number of queries that have been performed against the tables 158. The database table 235 identifies the table 158 associated with the secondary data structure 160 that is invalid. The secondary data structure 240 identifies the invalid secondary data structure 160. The library 245 identifies the library, directory, sub-directory, or schema that stores, contains, or is associated with the invalid secondary data structure 160.

FIG. 2B depicts a block diagram of an example presentation or display of the user interface 250 of the rebuild data 162 (FIG. 2A), according to an embodiment of the invention. FIG. 2B illustrates an example presentation only, and other forms of presentation may be used, including but not limited to presenting the rebuild data 162 via the speaker 131 (FIG. 1) using a text-to-speech conversion process.

The user interface 250 presents a reason 205-1 (which is an example of the reason 205), an operation 215-1 (which is an example of the operation 215), a most recent query 220-1 (which is an example of the most recent query 220), a number of parallel processors 225-1 (which is an example of the parallel processors 225), a query use count 230-1 (which is an example of the query use count 230), an identification of a database table 235-1 (which is an example of the database table 235), an identification of a secondary data structure 240-1 (which is an example of the secondary data structure 240), and an identification of a library 245-1 (which is an example of the library 245).

FIG. 3 depicts a flowchart of example processing for displaying the rebuild data 162, according to an embodiment of the invention. Control begins at block 300. Control then continues to block 305 where the database management system 154 receives a request from the application 156 that is directed to, or requests to access, the database 152 and/or the table 158. Examples of requests may include reads, writes, updates, queries, saves, restores, or any other appropriate type of requests.

The database management system 154 accesses the secondary data structure 160 in response to the received request. Control then continues to block 310 where, in response to the request, the database management system 154 determines whether the secondary data structure 160 is valid. The database management system 154 may make the determination of block 310 based on previous operations, functions, or requests that were performed on the journal 157, the secondary data structure 160, or the tables 158, based any errors, results, status, events, or conditions that occurred during or resulted from any previous operations, functions, or requests, or based on any other appropriate information.

If the determination of block 310 is true, then the secondary data structure 160 is valid, so control continues to block 315 where the database management system 154 performs the received request against the database table 158 using the valid secondary data structure 160. Control then continues to block 398 where the logic of FIG. 3 returns.

If the determination of block 310 is false, then the secondary data structure 160 is not valid and needs rebuilding, so control continues to block 320 where the database management system 154 determines the reason that explains why the secondary data structure 160 is invalid and needs rebuilding. The database management system 154 may make the determination of block 320 based on previous operations, functions, or requests that were performed on the journal 157, the secondary data structure 160, or the tables 158, based any errors, results, status, events, or conditions that occurred during or resulted from any previous operations, functions, or requests, or based on any other appropriate information. Control then continues to block 325 where the database management system 154 stores the determined reason 205 in the rebuild data 162 in the secondary data structure 160 and also in the rebuild data 162 in the database management system 154.

Control then continues to block 330 where the database management system 154 determines whether to continue the request despite the fact that the secondary data structure 160 is invalid. In various embodiments, the database management system 154 may make the determination of block 330 based on user input, based on the determined reason 205, based on the request, based on the table 158, based on the secondary data structure 160, based on the database 152, or based on any other appropriate criteria.

If the determination of block 330 is true, then processing of the request is to continue, so control continues to block 335 where the database management system 154 determines whether to rebuild the invalid secondary data structure 160. In various embodiments, the database management system 154 may make the determination of block 335 based on user input, based on the determined reason 205, based on the request, based on the size or other attribute of the table 158, based on the size or other attribute of the secondary data structure 160, based on the database 152, or based on any other appropriate criteria.

If the determination of block 335 is true, then the database management system 154 is to rebuild the invalid secondary data structure 160 prior to continuing processing the request, so control continues to block 340 where the database management system 154 rebuilds the invalid secondary data structure 160, creating key values and pointers in the secondary data structure 160 that point to corresponding rows in the table 158. Control then continues to block 315 where the database management system performs the request against the database 152 using the secondary data structure 160, which is now valid. The database management system 154 then returns a response to the request to the application 156. Control then continues to block 398 where the logic of FIG. 3 returns.

If the determination of block 335 is false, then the invalid secondary data structure 160 is not to be rebuilt prior to performing the request, so control continues from block 335 to block 345 where the database management system 154 performs the request against the database 152 without using the invalid secondary data structure 160. For example, the database management system 154 may access the table 152 by searching the table for a row that contains a key value of the request instead of accessing the table 152 via a pointer in the secondary data structure 160 to the row with the key value. The database management system 154 then returns a response to the request to the application 156. Control then continues to block 398 where the logic of FIG. 3 returns.

If the determination of block 330 is false, then the database management system 154 is not to continue processing the received request, so control continues to block 350 where the database management system 154 presents any, some, or all of the rebuild data 162, e.g., via displaying the rebuild data 162 via the user interface 250 (FIG. 2B) on the terminals 121, 122, 123, or 124 or by playing the rebuild data 162 via the speaker 131.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
deciding that a secondary data structure associated with a database needs rebuilding;
determining a reason that the secondary data structure needs rebuilding; and
presenting the reason via a user interface.

2. The method of claim 1, further comprising:
performing the deciding in response to a request to access the database.

3. The method of claim 2, further comprising:
presenting an identification of the operation associated with the request that encountered the secondary data structure.

4. The method of claim 1, further comprising:
presenting an identification of a most recent query that used the secondary data structure.

5. The method of claim 1, wherein the reason comprises:
an indication that a restore operation restored the database but not the secondary data structure.

6. The method of claim 1, wherein the reason comprises:
an indication that a failure occurred during a write operation to the database.

7. The method of claim 1, wherein the reason comprises:
an indication that the database was reorganized.

8. The method of claim 1, wherein the reason comprises:
an indication that a journal associated with the database encountered an error.

9. The method of claim 1, wherein the secondary data structure comprises an index.

10. The method of claim 1, wherein the secondary data structure comprises a hash table.

11. The method of claim 1, wherein the secondary data structure comprises a constraint.

12. A signal-bearing medium encoded with instructions, wherein the instructions when executed comprise:
deciding that a secondary data structure associated with a database is invalid, wherein the secondary data structure is used to access the database, and wherein the deciding is performed in response to a request to access the database;
determining a reason that the secondary data structure is invalid; and
presenting the reason via a user interface.

13. The signal-bearing medium of claim 12, further comprising:
presenting an identification of the operation associated with the request that encountered the secondary data structure.

14. The signal-bearing medium of claim 12, further comprising:
presenting an identification of a most recent query that used the secondary data structure.

15. The signal-bearing medium of claim 12, wherein the reason comprises:
an indication that a restore operation restored the database but not the secondary data structure.

16. The signal-bearing medium of claim 12, wherein the reason comprises:
an indication that a failure occurred during a write operation to the database.

17. The signal-bearing medium of claim 12, wherein the reason comprises:
an indication that the database was reorganized.

18. The signal-bearing medium of claim 12, wherein the reason comprises:
an indication that a journal associated with the database encountered an error.

19. A computer system comprising:
a processor; and
a storage device communicatively coupled to the processor, wherein the storage device is encoded with instructions, wherein the instructions when executed on the processor comprise:
deciding that a secondary data structure associated with a database is invalid, wherein the secondary data structure comprises a plurality of key values and a plurality of respective pointers to rows in the database associated with the key values, and wherein the deciding is performed in response to a request to access the database,
determining a reason that the secondary data structure is invalid,
presenting the reason via a user interface,
presenting an identification of the operation associated with the request that encountered the secondary data structure, and
presenting an identification of a most recent query that used the secondary data structure.

20. The computer system of claim 19, wherein the reason comprises:
an indication that a restore operation restored the database but not the secondary data structure.

21. The computer system of claim 19, wherein the reason comprises:
an indication that a failure occurred during a write operation to the database.

22. The computer system of claim 19, wherein the reason comprises:
an indication that the database was reorganized.

23. The computer system of claim 19, wherein the reason comprises:
an indication that a journal associated with the database encountered an error.

24. A method for configuring a computer, comprising:
configuring the computer to decide that a secondary data structure associated with a database is invalid, wherein the secondary data structure comprises a plurality of key values and a plurality of respective pointers to rows in the database associated with the key values, and wherein the deciding is performed in response to a request to access the database;
configuring the computer to determine a reason that the secondary data structure is invalid;
configuring the computer to present the reason via a user interface;
configuring the computer to present an identification of the operation associated with the request that encountered the secondary data structure via the user interface; and
configuring the computer to present an identification of a most recent query that used the secondary data structure via the user interface.

25. The method of claim 24, wherein the reason is selected from a group consisting of an indication that a restore operation restored the database but not the secondary data structure, an indication that a failure occurred during a write operation to the database, an indication that the database was reorganized, and an indication that a journal associated with the database encountered an error.
